(19) United States
(12) Patent Application Publication
(10) Pub. No.: US 2016/0101347 A1
(43) Pub. Date: Apr. 14, 2016

(54) Gaming Using Multiple Sets of Random Number Generators

(71) Applicant: Bruce Merati, San Diego, CA (US)

(72) Inventor: Bruce Merati, San Diego, CA (US)

(21) Appl. No.: 14/513,302

(22) Filed: Oct. 14, 2014

(51) Int. Cl. A63F 1/00; G07F 17/32

(52) U.S. Cl. CPC A63F 1/00; G07F 17/326

(57) ABSTRACT

Various apparatus and systems are described that allow variations on traditional games of chance. In one embodiment, a gaming system is described, comprising a gaming table, a first set of gaming values, and a second set of gaming values, wherein one or more gaming values from the first set of gaming values are randomly provided to a game player by a dealer during execution of a game played on the gaming table, and at least one of the second set of game values is randomly provided to the game player by the dealer during execution of the game in response to the game player requesting a game value from either the first or the second set of gaming values.

### BACKGROUND

I. Field of Use

The present application relates generally to the casino and gaming arts, whether played for real money or entertainment.

II. Description of the Related Art

Traditional casinos over the years have developed and offered a wide variety of games of chance to their customers. For example, a casino may offer traditional live gaming in the form of blackjack, poker, craps, and roulette. On a separate trail, in the last twenty years, online virtual gaming has been developed, simulating traditional live gaming, which has become increasingly more popular due to advancement in technologies. More recently, online live-dealer casinos enable individuals to play games such as blackjack; roulette and baccarat against live dealers over the Internet or on a private network within a casino's own resort and its affiliated gaming properties.

The Internet and social media sites have turned social gaming to a multi-billion dollar business. Social gaming revenues are mostly for sale of virtual goods or advertising, which are a form of in-game items that players pay for, either directly or indirectly. Social games are usually free to play; however players are encouraged to spend money to improve their accomplishments in the game. Social games can be similar to popular casino games, except that they are played with digital points rather than hard currencies. Generally, social gaming points are accumulated to win a prize, receive a promotion or get a discount for a purchase.

The gaming industry also has developed electronic games that are hosted by a live person or a robot dealing real playing cards but players use touch-screens devices offering electronic betting and payout. These electronic tables have partially automated components, and are a blend of a multi-station slot machine and a live dealer table game with some functionality performed automatically and some performed by a live dealer.

Increasingly, online gaming is moving towards live dealer gaming, viewable remotely on high definition real-time video feeds for games such as blackjack, roulette, baccarat, poker, and variations thereof for either real money, or for fun and entertainment on social networks such as Facebook.

Despite the best efforts by online gaming providers to prove the fairness of their virtual RNG games, there are always skeptics that computerized RNG games are not truly fair and as random. Most players prefer physical RNG's such as playing cards to virtual RNG's, live dealer online casinos therefore have been the natural evolution in online casinos' battle to win over these skeptics which also provide an enhanced gambling experience to players. The experience of playing against a live dealer online is the closest thing one can get to a traditional brick and mortar casino. As broadband connection speeds and live streaming technologies advances, so too does the quality and speed of a video stream of a live person dealing real cards or launching real balls in a roulette wheel.

A game of chance with a low degree of skill generally places a greater role on the chance element than the skill element. A game of chance with a high degree of skill, on the other hand, also includes an element of chance, but with the skill element playing a greater role in determining the game's outcome. On the other hand, a game such as chess is purely a game of skill with no element of chance.

Traditionally however, a game of chance with a high degree of skill, such as poker, is regarded as a game of skill even though chance plays a role in the game. In the gaming industry, the terminology for a game of skill is based on the assumption that in long term, the element of chance evens out, and players with higher skill levels win over less skilled players.

Some games of chance require more skill elements than others. For example in a game such as blackjack, a player uses statistical skills to make a decision as to hit or stand during the game, while in a game such as baccarat, a player needs to only make a decision as to the wager amount and whether to place a wager on bank, player or tie at the beginning of the hand. The rest of the game will depend on pure chance, as traditional baccarat rules do not require a player's decision during the game in determining the game's outcome.

A random number generator could be any randomizing device such as playing cards, dice, roulette wheels, or number balls drawn from a container for games such as bingo, keno or lottery. A random number generator could also be implemented by a processor executing machine-readable instructions that cause the processor to generate random numbers, simulating one of the physical random number generators mentioned above.

Depending on the type of game and its rules, a game value may have more than one variable, for example in poker, both the number value and the suit value of a card matters and in a game such as baccarat and blackjack only the number values of playing cards matter to the game and the suits do not affect the game's outcome. In a game such poker, a full deck or a subset of a deck of playing cards are used with no duplication of game values. In a game such as blackjack or baccarat, the game can be played with multiple decks of cards and duplication of cards drawn from a multiple decks of cards, overall, do not affect the game and its results.

A player's card counting may overcome the house advantage in games such as blackjack and baccarat. To make card counting difficult, casinos use as many as eight decks of cards and shuffle them before all the cards are drawn. The fewer decks of cards used, the higher chance of card counting and therefore the higher need for more frequent reshuffling to avoid card counting. In a single deck blackjack game, the dealer may have to shuffle the cards after less than 50% of the cards being dealt, and with eight decks the dealer may go through more than 70% of the cards before the statistical needs of shuffling the cards. The gaming industry also has developed continuous shufflers to automatically shuffle one or more packs of cards continuously.

Player psychology and emotion play a major role in a game of chance regardless of whether the game is played for real money or for points. As much as gaming operators try to make a game such as blackjack a fair game and make the cards as random as possible, players sitting at a blackjack table often get upset when another player does not play according to best strategy of the game. For example if the dealer's face up card is a 4 and a player sitting at the last position of the table takes a card on a 15 and the card turns out to be a 10 thus busting the player, it will make other players upset, often leaving the table because they believe the player should have not hit on 15 and should have let the dealer to draw the 10 which would have busted the dealer's hand. However, if the player's card turned out to be a 5 and the dealer's face down card was an 8 followed by a and a 10, thus busting the dealer, other players at the table consider the player at the last position of the table to have brought luck to the table.

In a game such as baccarat, Chinese players often have an illusion of control over the game's outcome believing that luck and faith could help them win even though they know the game's odds are against them. When reading the cards of a baccarat game, Chinese players peel the cards one at a time to reveal the card's values, by peeling the longer side of the card first, then moving to the width and then back again. This card reading behavior is almost a similar ritual amongst most Chinese players believing that they can actually change the outcome of a card by the way they squeeze the card. Some Chinese players are even more superstitious, sometimes even blowing on the cards, hoping to “blow away” bad numbers. Most baccarat players keep careful track of the shoe history on paper or follow a scoreboard displaying the game history since the shoe began for predicting the next hand's game outcome. Any changes that would result in the traditional gameplay, or tools players are accustomed to, could affect players' psychology and willingness to embrace the change.

Many games offer side bets, for example in blackjack, players can place a side bet at the beginning of a hand on various outcomes such as player's initial hand is a pair or player's initial hand is suited. A side bet that results in one or more cards being dealt out of sequence could affect a player's emotion, even though logically they shouldn't as the cards are shuffled and dealt as random as possible. Casinos therefore try to avoid offering a side bet that changes the normal play sequence of a traditional game such as blackjack.

Most side bets are offered before a game starts. Even though offering a side bet during a game could increase an operator's gaming revenues and could add more excitement to the game, they are usually not offered by a gaming operator. One of the reasons that side bets are rarely offered during a game is because skilled players may get an edge on the house by increasing their bets as more cards are drawn by the dealer and the fewer cards remaining gives a skilled player the ability to detect a biasedness trend towards value of certain cards. Another reason operators avoid a side bet that results in change of drawing cards is that drawing cards out of a game's already shuffled sequence could affect some players' psychologically.

Regardless of the type of games played, a live game traditionally uses only one set of random numbers, for example in blackjack or in baccarat, the dealer may use as low as one deck to as many as eight decks of shuffled cards. However, regardless of the number of decks used, the dealer uses only one set of game values.

Thus, it would be desirable for casinos or online gaming sites to introduce new side bets to games that players are already intimately accustomed to without upsetting their perception and phycology.

### SUMMARY

The embodiments described herein relate to apparatus, systems, and methods for incorporating multiple sets of game values into games of chance, allowing one or more game players and/or game participants to choose a source from which to receive one or more game values.

In one embodiment, a gaming system is described, comprising a surface on which to play a game, first means for providing a first random gaming value to a game player on the surface during execution of the game, and second means for providing a second random gaming value to the game player on the surface when a predetermined event occurs, the second random gaming value provided in response to an instruction from the game player to receive the second random gaming value.

In another embodiment, another gaming system is described, comprising a gaming table, a first set of gaming values, and a second set of gaming values, wherein one or more gaming values from the first set of gaming values are randomly provided to a game player by a dealer during execution of a game played on the gaming table, and at least one of the second set of game values is randomly provided to the game player by the dealer during execution of the game in response to the game player requesting a game value from either the first or the second set of gaming values.

In yet another embodiment, yet another gaming system is described, comprising a first set of physical game values, a memory for storing machine-readable instructions, an electronic random game value generator, a user interface, a processor coupled to the game value recognition device, the memory, the electronic random game value generator, and the user interface for executing the machine-readable instructions that cause the gaming system to receive an indication from a player of the game, from the user interface, of a selection by the player to receive a random game value from either the first set of physical game values or the electronic random game value generator. When the indication indicates selection of the random game value generator, providing an electronically-generated random game value to the user interface for use by the player in the game.

### BRIEF DESCRIPTION OF THE DRAWINGS

The features, advantages, and objects of the present invention will become more apparent from the detailed description as set forth below, when taken in conjunction with the drawings in which like referenced characters identify correspondingly throughout, and wherein:

FIG. 1 is a perspective view of a system 100 for playing a game of cards utilizing first and second random game value generators;

FIG. 2 illustrates a functional block diagram of a system for playing a game using two or more random game value generators, related to the system described in FIG. 1;

FIG. 3 is a functional block diagram of another embodiment wherein a second random game value generator comprises a remote server;

FIG. 4 illustrates a functional block diagram of one embodiment of the server shown in FIG. 2;

FIG. 5 is a functional block diagram of one embodiment of the invention, shown as electronic gaming machine;

FIG. 6 is a functional block diagram describing another embodiment, where the systems shown in FIG. 1, 2, or 3 allow remote participants to place wagers on the outcome of a game;

FIG. 7 is a functional block diagram of one embodiment of a method for playing a modified game of baccarat, using the principles disclosed herein;

FIG. 8 illustrates one embodiment of an automated sorter that distinguishes between each set of game values, e.g. cards from a first source of game values vs. cards from a second source of game values.

### DETAILED DESCRIPTION

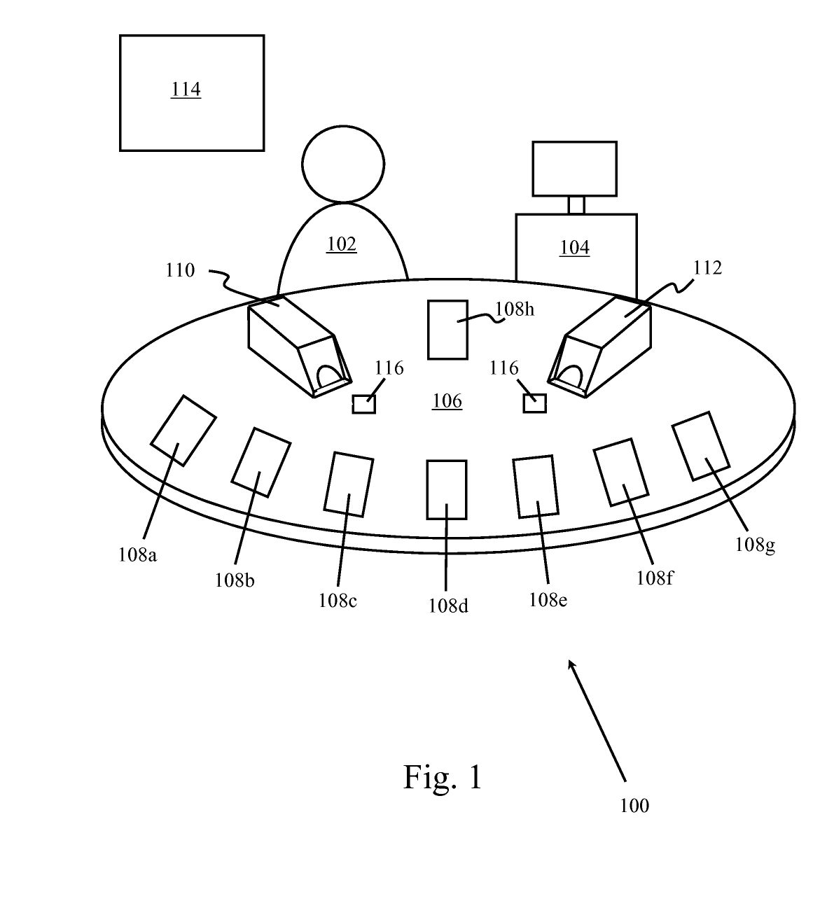

FIG. 1 is a perspective view of a system 100 for playing a game of cards utilizing a live dealer 102 or robotic dealer 104 to conduct and monitor game play. The system 100 comprises a gaming surface 106, typically a gaming table commonly found in any casino. Gaming tables are generally constructed to allow a number of players to play a game against a house entity (i.e., blackjack, baccarat, roulette, craps, or keno against a live/robotic dealer) or against other players hosted by a live/robotic dealer (i.e., Texas Hold'Em, draw poker, stud poker, bingo). In the example shown in FIG. 1, seven areas 108a-108g are designated on surface 106 for use by seven game players, respectively, the areas 108 serving as an approximate area for the game player to place their cards. Similarly, area 108h is an area designated for the dealer to place his/her/its cards, if a game is being played that requires a dealer hand. The system 100 further comprises at least two random game value generators 110 and 112, in this case, two “card shoes” are shown, each used to hold one or more decks of physical playing cards. Shoes are commonly used in the casino industry to minimize time between shuffles, and to deter fraud and card counting.

The use of the term “physical” herein denotes a two or three dimensional object or location. For example, “physical game values” may include such things as playing cards, bingo balls, mechanical dice, mechanical roulette wheels, mechanical wheels of chance, or any tangible object capable of generating random numbers or game values. With reference to places, the term “physical” herein denotes a three-dimensional room, establishment, a casino, a racetrack or any other actual location where gaming may take place.

Traditionally, a live dealer provides physical playing cards to one or more players at a gaming table from a single shoe. In certain games, such as blackjack, psychology and emotion may play a major role in determining things such as how much money to bet on each hand, whether to play in accordance with the best mathematical strategy, or when to deviate from optimal basic strategy. For example, the best calculated odds in blackjack when the dealer is showing a 5 and a player has a hand worth 15 is to “stand” and let the dealer take the next card, hopefully resulting in a “bust”. Players often get upset when another player does not play in accordance with the best mathematical strategy. For example, if a blackjack player receiving cards at position 108g holds a 20, another player at the 108a position holds a 15, and the dealer's upcard is a 6, if the player at position 108a takes a card and the card turns out to be a 10, it will cause that player to bust, and possibly make the other player upset, because the dealer most likely would have busted if the player at position 108a did not take a hit, resulting in players who have not already busted winning the round of play. The player at position 108g may even leave the table because he believes that the player at position 108a should have not hit on 15 and should have let the dealer to draw the 10, which would have resulted in the dealer's hand going bust. Some players place great emphasis on believing that the cards in the shoe should not be “disturbed” by errant game play by those who may not follow the best mathematical strategy.

Along the same lines as above, i.e., an emphasis on not disturbing the order of cards in a shoe, is the use of side bets during game play. A side bet during game play may result in one or more cards being dealt from the shoe “out of sequence”, which could negatively affect a player's phycology and emotions. Casinos therefore try to avoid allowing side bets that change the normal sequence of traditional games such as blackjack and baccarat.

The use of two or more random game value generators can be used to overcome the psychological and emotional effects of allowing side bets in traditional casino games, because use of a secondary random game value generator preserves the order in which cards are provided by a primary random game value generator. This may also allow players to feel more in control of game outcomes, while not disturbing the psychological expectations of other players.

In one embodiment, two physical, random game value generators are used to play a traditional casino game, such as blackjack, baccarat, poker, keno, bingo, roulette, craps or other casino games. In any card game, one or both generators can comprise one or more decks of physical playing cards or a sub-set of a traditional deck of playing cards. If a shoe is used to house one or both sets of cards, the shoe may be considered to be a random game value generator and the cards considered to be random game values. In this embodiment, one of the random game value generators is used as a primary source of cards for the traditional game. The other random game value generator may be used for side bets or, in other embodiments, used as a source of random game values when either the dealer or a player is allowed to select which random game value source to receive a next game value. For example, in a game of blackjack, where all of the player positions on gaming surface 106 are occupied, the players and the dealer receive their traditional, initial 2 card blackjack hands from the first random game value generator (e.g., random physical playing cards from a first shoe). As players and the dealer take “hits” during game play, they receive one or more additional cards from the first shoe. If a player wants to place a side bet, for example, a wager that the next card will be a 10 or greater, or change one or more of his cards for a fee, the player may do so, and will receive the next card (or cards, depending on the type of side bet) from the second shoe. In this way, side bets may be accommodated without interrupting the order in which cards are dealt from the first shoe.

A similar concept can be applied to non-card games. For example, in bingo, a first bin of physical bingo balls may be used to complete a first bingo game (e.g., a straight line), while a second bin of physical bingo balls may be used to continue the game to a more complex result (e.g., an “X”). In craps, a first set of physical dice may be used to play a traditional game of craps, while a second set of physical dice may be used for wagers involving side bets.

In one embodiment, the random game value generators may comprise different physical characteristics from one other. For example, in one embodiment, a first random game value generator may comprise a single, or multiple, deck(s) of physical playing cards, while a second random game value generator may comprise playing cards having different game values than traditional numbering and suits, a physical spinning “wheel of fortune” having one or a number of game values pertinent to the game being played, a physical bin of physical objects, such as bingo-type balls or tickets, each assigned a particular game value, or an electronic device capable of generating random game values. Of course, any combination of these random game value generation types could be used to offer traditional casino games having side bets, or to allow players to choose which random game value source to receive one or more game values during the course of game play.

In one embodiment, two or more random game value generators are used to allow the dealer, one or more players, or both, to choose a source of at least some random game values provided during the course of game play. For example, before a game of baccarat is played, a player (or participant) may indicate to a dealer that he or she would like the initial “bank” hand to be dealt from a first random game value generator, and the initial “player” hand to be dealt from a second random game value generator. In one embodiment, the participant pays a small fee to the house for allowing the participant to determine the source for each of the hands. In a related embodiment, after the initial 2-card bank and player hands are dealt, the participant may place a side bet before the final card is drawn, for example, the bank hand beating the player hand at the conclusion of game play. Based on the side bet, the participant may be allowed to select which random game value generator to use as a source for a third card to be provided to either the bank hand, the player hand, or both, in accordance with the rules of baccarat. More details of this embodiment are described below.

In embodiments that allow a player to determine a source of random game values for one or more game values during game play, the player may be offered to do so at only certain, predetermined points during game play and/or upon the occurrence of one or more events. For example, a player may only be allowed to choose a random game value generator a) if a side bet is placed, b) before game play begins, c) if a player pays a fee to the house, d) before the flop, turn, or river cards are dealt in a game of Texas Hold'Em, and/or e) after a certain number of bingo balls have been drawn. Similarly, a dealer may be given an option to determine a source of random game values for one or more game values during game play, the dealer may be offered to do so at only certain, predetermined points during game play and/or upon the occurrence of one or more events.

In another embodiment, a player may be given an opportunity to exchange one or more game values for substitute game value(s) from a random game value generator of his or her choosing. Typically, the player pays a fee for this privilege. After payment, the player surrenders one or more game values and receives one or more substitute game values randomly provided by a random game value generator of the player's choosing. Substitution may occur at any point during the game, including after the player has been given his or her final game value(s), but generally before a winner is determined.

While most traditional games of chance allow at least some level of duplication between game values, others do not. For example, in a game of blackjack where 8 decks of cards are used in a shoe, each game value of a 52 card deck is duplicated 8 times, so that during any round of game play, the eight of spade, for example, may be dealt to three players and not affect the game. However, in bingo, no game value duplication can be tolerated, i.e., each draw of a bingo ball must result in a unique alpha-numeric combination. Therefore, in one embodiment, in games that cannot tolerate duplicative game values, when a player (or dealer) receives a game value from a second random game value source, and that game value has already been played, or is currently being held by a player or the dealer, the game value from the second random game value source is discarded, and another random game value is provided from the second random game value source. This process may be repeated if the second and subsequent random game value from the second random game value source results in another duplication. For example, in a live bingo game played at a first physical bingo hall, a player may call bingo for a one line pattern after the first 20 out of 75 balls are drawn. The game could continue, requiring a new pattern, such as an “X”, using a full second set of 75 balls at a second location, where drawn balls are matched against the first 20 balls at the first physical location, ignoring all duplicate drawn numbers and drawing new balls until a ball is drawn that has not been played at the first location.

In some embodiments, the dealer may, either alternatively or in addition to the player, choose which source of random game values to provide to one or more players during the course of game play. For example, in one embodiment, a dealer may select which of two shoes to provide a final card to each player in a hosted game of 5 card stud. In another example, a player may be given an option to choose from two or more available sets of game values to receive initial game values, and the dealer has the sole option in choosing which set of game values to use during subsequent game play. For example, before the game starts in a game such as blackjack, a player may allowed to select the initial two cards from a first shoe or a second shoe. Thereafter the dealer selects which shoe to draw cards from as game play progresses around the playing surface 106 to make the drawing as random as possible to avoid card counters getting an advantage to beat the house's statistical advantage.

The option given to players to select as to which set of random number generators to draw from gives an illusion of control to the players and also will introduce a new element of chance, superstition and excitement to games. The option given to a dealer to select a source of random game values entices the house to offer more exciting wagering opportunities to their players during traditional casino games, thus creating more revenues for the industry. Allowing a dealer to select the source of random values additionally allows the house to minimize the risks associated with card counting.

The dealer's choice to draw from two random game value sources could overcome some game players' psychology. For example, in a multi-deck game of blackjack, a player may be given the option to exchange his last card after being busted for a fee. If the player accepts this option and receives a new card from the same shoe that other players receive their “traditional” cards during the game, the order of cards dealt to the other players would change, thus affecting their psychology that a card that would have otherwise been dealt to them was given to the player that exchanged a card. However, if a second set of game values were available to the dealer, the dealer could provide cards from the second set of game values to players wishing to exchange their card(s), thus preserving the order of the cards in the shoe. This, in turn, prevents some players from feeling “disturbed” by what would otherwise be an “interruption” in the dealing process.

As mentioned above, in one embodiment, a second set of random game values could be provided by electronic device 114, located within view of a dealer and/or players at gaming surface 106, such as a computer, tablet, laptop, or custom computing device, any one of these comprising an executable instructions stored in memory for a processor to generate random game values. For example, in a game of Texas Hold'Em where the initial cards, the flop, and the turn cards are provided to players using a physical deck of 52 playing cards, the river card could be provided by such an electronic device upon manipulation of electronic device 114 by the dealer. For example, the processor could generate and display a randomly-selected, electronic version of one of the 52 possible card values in a deck of playing cards upon the dealer touching a touch-screen display of the electronic device 114. In this embodiment, it may not be desirable if the game values generated by the electronic device are duplicative of any of the cards face-up on the gaming surface 102. In this case, the game value initially generated by the electronic device may be disregarded by the dealer by providing manipulating electronic device 114 a second time, thus generating another random, electronic game value to replace the disregarded game value.

In a related embodiment, one or more game value detectors 116, such as a card reader, may be used to read the value of cards and provide electronic representations of the cards to electronic device 114. In this embodiment, the processor inside electronic device 114 removes any game values already provided to players/dealer from being considered as a subsequent game value. Such a process is described in co-invented U.S. Pat. Nos. 8,162,760 and 8,414,401, the contents of which are expressly incorporated by reference herein. Using this technique, game values provided by electronic device 114 may be removed from being considered by the processor during the game value generation process, thus providing only electronic game values that have not been previously dealt by the dealer. In other embodiments, game value detector 116 could be incorporated as part of a random game value generator, such as a card reader incorporated into a card shoe. In this case, as physical game values are generated by one or both shoes, they may be identified by each, respective game value detector 116 and electronic representations of such values may be provided to electronic device 114, either by wired or wireless means. In the card shoe embodiment, game value detector 116 identifies the card values as the cards are dealt from the card shoe.

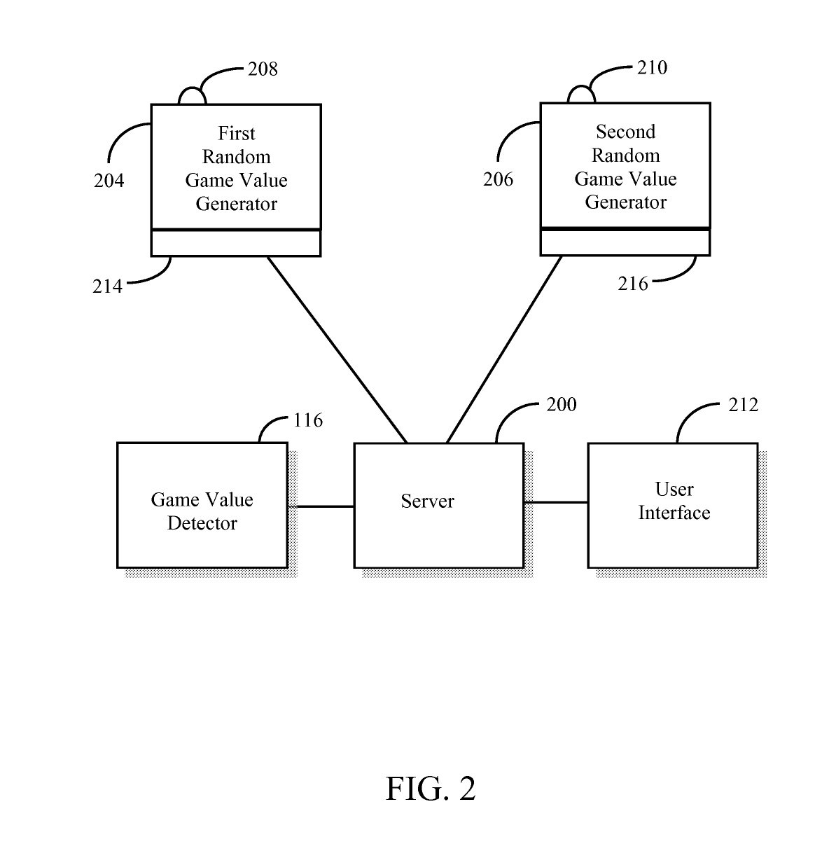

FIG. 2 illustrates a functional block diagram of one embodiment of a system for playing a game using two or more random game value generators, related to the system described in FIG. 1. Shown are server 200, game value detector 116, first random game value generator 204, second random game value generator 206, first indicator 208, second indicator 210, first receiver 214, second receiver 216, and user interface 212. In practice, a number of user interfaces may be used, one for each player, however only one is shown in FIG. 2 for purposes of simplicity. In this embodiment, first random game value generator 204 and second random game value generator provide random game values locally to players in proximity to gaming surface 106. In one embodiment, first random game value generator 204 comprises a first shoe randomly loaded with one or more decks of physical playing cards, and second random game value generator 206 comprises a second shoe randomly loaded with one set of physical playing cards.

A live dealer deals cards from the first shoe during at least a portion of each round of game play. For example, during a game of blackjack, the dealer may provide initial 2-card hands to each player and to the dealer using first random game value generator 204. In baccarat, an initial 2-card bank hand and player hand may be dealt using first random game value generator 204. As these cards are dealt, they are passed in proximity to game value detector 116 for generating electronic signals representative of the game values. For example, game value detector 116 may comprise a card reader or a camera. The electronic representations are provided to server 200, where they may be stored and/or evaluated to determine, for example, a score associated with the initial hands. For example, the value of each 2 card initial blackjack hand can be determined by server 200 using traditional rules of blackjack, or the value of the initial bank and player hands can be determined using traditional rules of baccarat if a game of baccarat is being played.

In this example, once the initial hands are provided by the dealer from the first random game value generator 204, a player may sometimes be allowed to place a side bet, for example, wagering that the next card played will be a face card. In this example, the player may place such a side bet, and then be provided a card from second random game value generator 206, so as not to disturb the order of the cards in the first shoe. In another embodiment, the player who placed the side bet may choose which of the two random game value generators to receive the card used for the side bet. In this case, such a player may use user interface 212 to provide an indication to server 200 of the player's choice of random game value generators. User interface 212 comprises a mechanical, electronic, or electro-mechanical device for providing an electronic signal to server 200 to indicate which random game value generator to choose for one or more subsequent cards dealt by the live dealer. Such a device may comprise a simple pushbutton switch incorporated into gaming surface 106, or it may comprise a player's smartphone, tablet, or other personal wireless computing device running an application that sends wireless signals to server 200 via, for example, Bluetooth, Wi-Fi, or cellular data.

In response to receiving a player's random game value generator selection, server 200 may provide a signal to one or both of the indicators for illuminating the indicator associated with the selected random game value generator. In another embodiment, server 200 comprises the indicators, rather than being located on each of the random game value generators. In an embodiment where the indicators are located on the random game value generators, each of the indicators 208 and 210 is coupled to a respective battery-powered, wireless receiver 214 or 216, respectively, for receiving wireless or wired signals sent by server 200. When one of the indicators receives the signal from server 200, it illuminates, indicating to the dealer which shoe to provide the next card. As the dealer provides the next card from the shoe selected by the player, it is read by game value detector 116 and provided to server 200. In response, game server 200 may transmit a signal to the illuminated indicator with a command to de-energize that indicator.

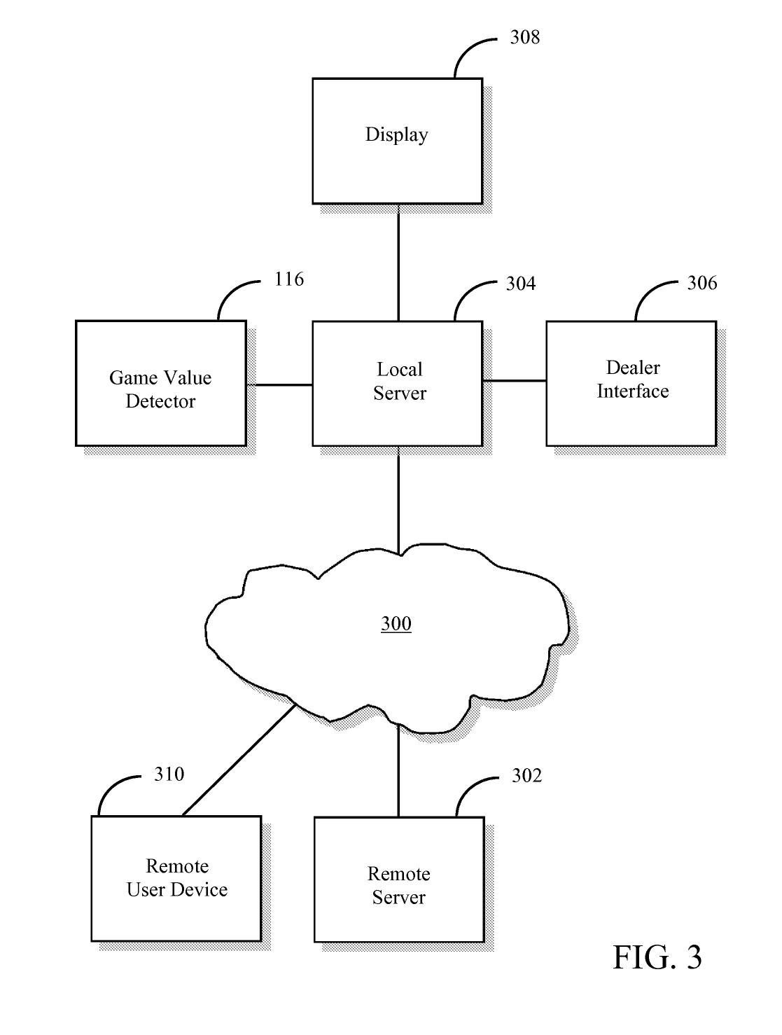

In another embodiment, as shown in FIG. 3, the second set of game values could be generated via a remote server 302 in communication with a local server 304 over network 300 (e.g., the Internet). Local server 304 may utilize dealer interface 306 for providing input to local server 304 in order for local server 304 to send a signal to remote server 302, over communication network 300, to generate one or more random game values during certain points during game play. Dealer interface 306 could comprise any variety of electronic devices able to receive input from a person, typically a live dealer or, in other embodiments, any of the game players, and provide a signal representative of the person's desire for remote server 302 to generate one or more random game values for use in playing a game being conducted locally at a gaming location. Dealer interface 306 comprises a user interface comprising one or more input devices, such as pushbuttons, knobs, switches, touchscreens, etc., to receive commands from a person. It may also comprise an output device comprising a visual display device and/or speaker for providing the electronic, random game values generated by remote server 302 to a live person, such as a dealer or game players. Dealer interface 306 may additionally comprise means for communicating with server 304 by well-known wired and/or wireless means, such as Wi-Fi, Bluetooth, or hard wire. Server 304 comprises an electronic computing device comprising a memory for storing machine-readable instructions and a processor to execute the instructions which causes server 304 to receive signals from dealer interface 306, send signals to remote server 302, receive random, electronic game values from remote server 302, and provide them to a display 308 proximate the dealer for the dealer and/or players to view. In one embodiment, the random, electronic game values from remote server 302 are provided to dealer interface 306 prior to presentation on display 308. In this embodiment, the live dealer determines when to reveal the electronic, random game value(s) to the players by pressing one or more buttons or otherwise operating dealer interface 306. Then, the random, electronic game values are provided to display 308.

Remote server 302 comprises a memory for storing machine-readable instructions and a processor to execute the instructions which causes server 302 to receive signals from dealer interface 306, generate one or more electronic, random game values (such as electronic versions of playing card values, bingo ball values, roulette values, dice values, etc.), and send these game values to remote server 302.

It should be understood that the functionality of the just-described system could be arranged in alternative arrangements. For example, the functionality of local server 304 and display 308 could be incorporated into dealer interface 306, with dealer interface 306 coupled to network 300 for communicating with remote server 302.

In another embodiment, the system of FIG. 3 additionally comprises game value detector 116. Game value detector 116 comprises a detection and conversion device to convert physical game values, such as playing card values, bingo ball values, roulette values, dice values, etc., into electronic game values, and provide the electronic game values to either local server 304 and/or remote server 302. Embodiments of game value detector 116 may include a card reader, a digital camera, a magnetic sensor, an RFID reader, etc. In embodiments that utilize game value detector 116, game value detector 116 may provide electronic game values to remote server 302, either directly via network 300 or through local server 304, for use by remote server 302 in eliminating duplicate game values as a game is being played. For example, in a game of draw poker, where players may choose whether to receive replacement cards from a deck of cards dealt by a live dealer or from remote server 302, it is generally undesirable to have remote server 302 randomly generate a card that has already been dealt to one of the players by the dealer. To avoid this, remote server 302 receives electronic representations of the physical game values (playing cards) as they are provided to the players. Then, remote server 302 excludes those values from being provided to local server 304 when a request is received to provide one or more electronic, random game values. Exclusion of the electronic game values received from game value detector 116 may include storing each of the electronic game values received from game value detector 116, comparing each randomly generated game value by remote server 302 to the stored values, and re-generating another value if a match is determined between the just-generated game value and any of the game values stored in memory.

In a related embodiment, an online player may play a “hybrid” game that is hosted by remote server 302 using remote user device 310 in communication with remote server 302 via network 300 (e.g., a smart phone, tablet, desktop computer, etc.). The hybrid game comprises an electronic, or “virtual” game where the online player receive electronic game values from a first random game value source, such as remote server 302, and play against a live dealer, the “house”, other online players, and/or live players seated at gaming surface 106. In this embodiment, at least the live dealer, the house, or one or more live players receive game values from a second source, such as one or more decks of physical playing cards. An electronic representation of the physical game values used during the game is provided to server 302 via one or more game value detectors 116, typically via local server 304 and network 300, so that remote server 302 can determine a winner between an online player and a live dealer.

For example, remote server 302 may offer hybrid blackjack to online players. An online player may log into remote server 302 to play the hybrid game and place a wager electronically using remote user device 310. In one embodiment, remote server 302 uses a set of game values (e.g. electronic representations of each card in a 52 deck of physical playing cards) that is an electronic equivalent of a set of physical game values (e.g., a deck of 52 physical playing cards) that is used by a live dealer at gaming surface 106. In one embodiment, the game begins by remote server 302 generating two random card values and providing them to the online player via network 300 and remote user device 310. The live dealer deals two physical playing cards to any live players at gaming surface 106, and two cards to himself/herself as the dealer or “house”, one card face up and the other face down. At least the dealer's cards are recognized by game value detector 116, in this example, a card reader. In another embodiment, all of the cards dealt by the dealer are read by game value detector 116. Electronic representations of the cards are then provided to remote server 302 via, in one embodiment, local server 304 and network 300.

Remote server 302 receives the electronic representations provided by game value detector 116 and provides at least the dealer's electronic representation of the dealer's upcard to the online player via network 300 and remote user device 310. The online player may then send electronic signals to remote server 302 indicating whether he or she would like to “hit”, “stand”, double down, etc. Remote server 302, in response provides one or more random, electronic game values (e.g., electronic representations of physical playing cards) to the online player if the online player has requested a hit, double down, etc.

After the online player is finished receiving game values from remote server 302, or if the online player “stands pat”, the dealer turns his/her “hole” card face up, and an electronic representation of the value of the hole card is revealed to the online player. In another embodiment, the live dealer may deal physical cards to live players at gaming surface 106 playing against the live dealer in accordance with each live player's desire to hit, stand, double down, split, etc. In one embodiment, each card provided by the live dealer is read by game value detector 116 and an electronic representation provided to remote server 302.

After the dealer has concluded his/her hand, either by “busting” or attaining a score typically between 17 and 21, remote server 302 determines whether the online player has won the round of play by comparing the player's blackjack score (as determined by adding the electronic game values provided to the online player by remote server 302) to the dealer's score (also determined by remote server 302) by adding the electronic representations provided from game value detector 116. If the online player has a higher score than the dealer's score, the player wins the round and vice-versa. A tie may occur if the online player's score is equal to the dealer's score.

After conclusion of the round of game play, described above, another round of game play may ensue. In one embodiment, the dealer shuffles the physical playing cards and provides a signal to the remote server 302 that a shuffle is taking place, using dealer interface 306. In response, remote server 302 “resets” the set of electronic game values available for the next round of play to include all 52 electronic versions of the 52 physical playing cards available to the live dealer to play the next round.

In another embodiment, for example where a number of decks of physical playing cards are used by the live dealer, the next round of play occurs without shuffling. In this case, in one embodiment, remote server 302 may exclude game values that have already been dealt by the live dealer from being randomly generated and provided to the online game player, to limit the occurrence of duplicative game values, as explained in co-invented U.S. Pat. Nos. 8,162,760 and 8,414,401.

In another embodiment, electronic game values generated from game value detector 116 are provided to local server 304, and local server 304 stores these values for comparison to incoming electronic, random game values generated by remote server 302 prior to sending the random, electronic game values to dealer interface 306 and/or display 308. If a match if found, local server 304 sends remote server 302 a command to provide one or more replacement game values to local server 304 to replace the electronic, random game values that matched the game values stored in the memory. This process may repeat until no duplicates are determined by local server 304.

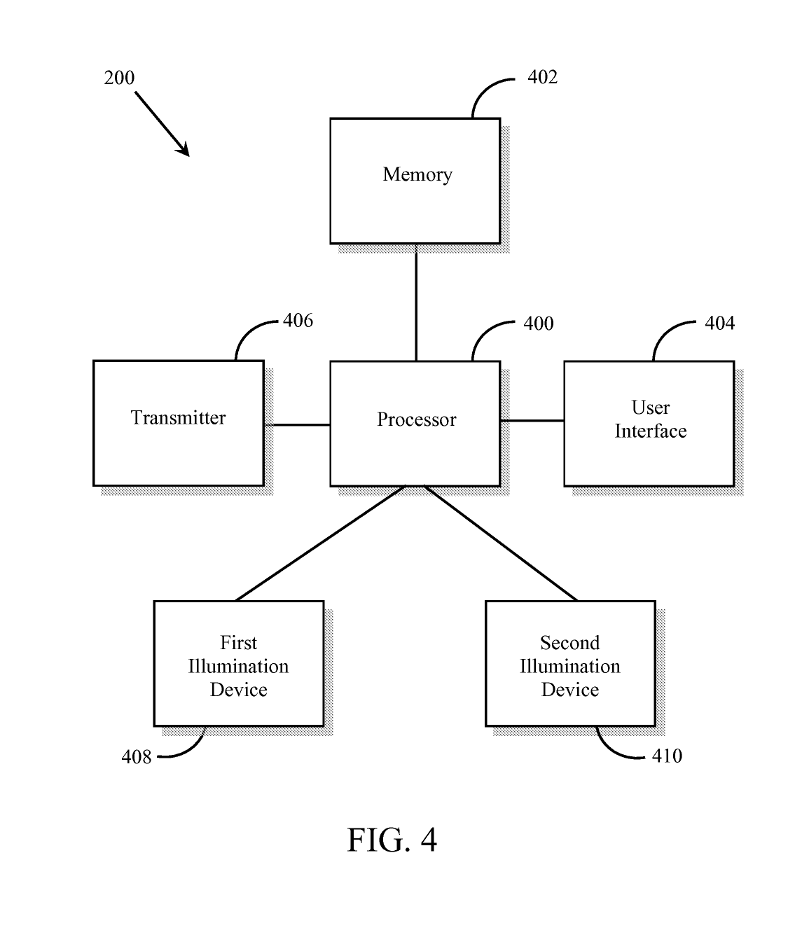

FIG. 4 illustrates a functional block diagram of one embodiment of server 200. Shown are processor 400, memory 402, user interface 404, transmitter 406, and two or more optional illumination devices 408 and 410.

Processor 400 comprises a general-purpose microprocessor well known in the art or it may comprise a custom or semi-custom ASIC. Processor 400 generally executes machine-readable instructions stored in one or more non-transitory media, such as memory 402. Examples of memory 402 comprise one or more electronic memories such as RAM, ROM, hard drive, flash memory, EEPROMs, UVPROMs, etc. User interface 404 comprises any hardware necessary to receive electronic signals from players, indicating which of two or more random game value generators for the dealer to use when dealing a subsequent game value or multiple game values. In some embodiments, user interface comprises wireless circuitry to receive wireless signals transmitted from player's smartphones, tablets, or other personal computing devices. Transmitter 406 comprises circuitry and/or firmware configured to wirelessly transmit electronic signals between server 200 and two or more indicators located on two or more random game value generators, respectively (not shown). Such circuitry/firmware is well known in the art. Illumination devices 408 and 410 generally comprise a visual indicator of some sort, such as LEDs or other well know devices and may be used in an embodiment where server 200 is in view of a dealer and players to indicate to the dealer which of two or more random game value generators to draw the next random game value from. In that case, processor 400 provides an illumination signal to the respective illumination device corresponding to the random game value generator associated with the random game value generator chosen by the player or dealer

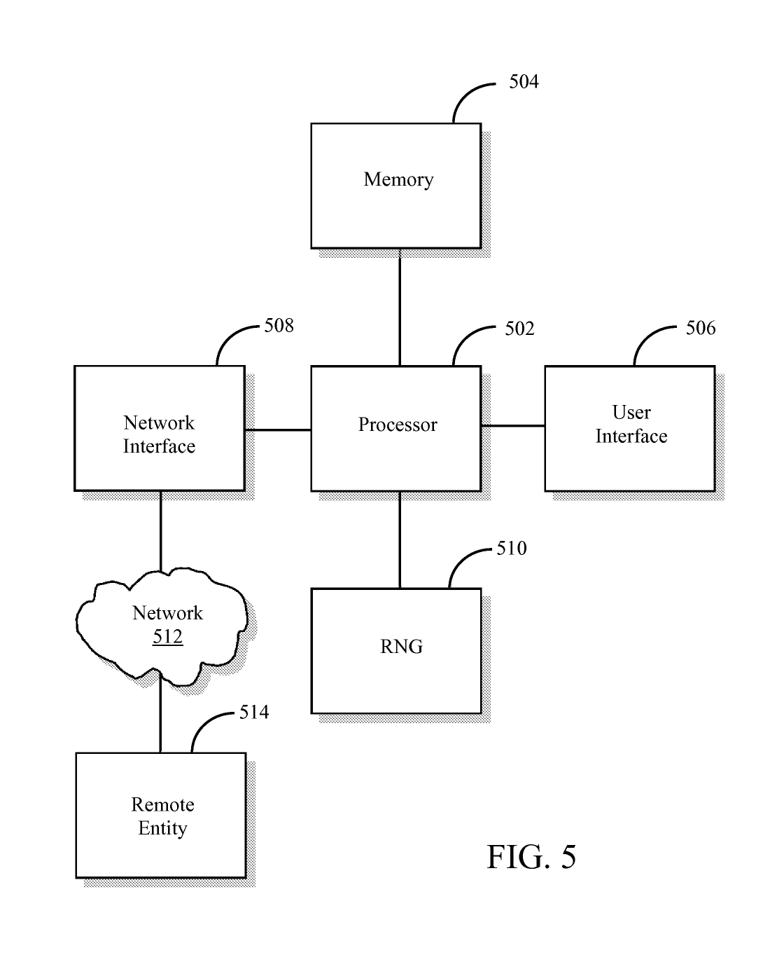

FIG. 5 is a functional block diagram of one embodiment of the invention, shown as electronic gaming machine 500. Electronic gaming machine 500 comprises a processor 502, a memory 504, a user interface 506, a network interface 508, and an electronic random number generator 510. In this embodiment, an electronic game such as blackjack, poker, baccarat, keno, craps, roulette, bingo, or some other game of chance, is offered to players. The game utilizes two or more random game value generators, one comprising processor 502 executing machine-readable code stored in memory 504 that causes the electronic gaming machine to generate random game values for use in the game being played. In another embodiment, RNG 510 is used as the first random game value generator. RNG 510 comprises any well-known random number generation hardware/firmware device to generate random or pseudo-random numbers for processor 502 to use to generate random game values appropriate for the type of game being played. Processor 502 comprises a general-purpose microprocessor well known in the art or it may comprise a custom or semi-custom ASIC. Processor 502 generally executes machine-readable instructions stored in one or more non-transitory media, such as memory 504. Examples of memory 504 comprise one or more electronic memories such as RAM, ROM, hard drive, flash memory, EEPROMs, UVPROMs, etc. User interface 506 comprises any hardware and/or firmware able to receive player input and convert the player input into electronic signals used by processor 502. Such input comprises player selection of one of two or more random game value generators. At one or more points in the game, a game player may select a source of the next random game value to be provided to the player, for example, at a point in blackjack where the player may choose to hit, in baccarat after the bank and player hands have been provided, when a player replaces one or more cards in draw poker, upon placement of a side bet, etc. Upon receiving an indication from the game player via user interface 506, a request is sent by processor 502 via network interface 508 over network 512 (e.g., the Internet or an intranet) for remote entity 514 to provide one or more random game values. In response, remote entity 514, such as a server or a website that provides random numbers (such as www.random.org or www.randonumbergenerator.com) provides one or more random numbers to processor 502 via network interface 508. In response, processor 502 either uses the random values provided by remote entity 514 directly, or generates suitable game values from the random values provided by the remote entity, and displays them to the game player via user interface 506. In this way, the game player may select a source of one or more game values at one or more points during game play.

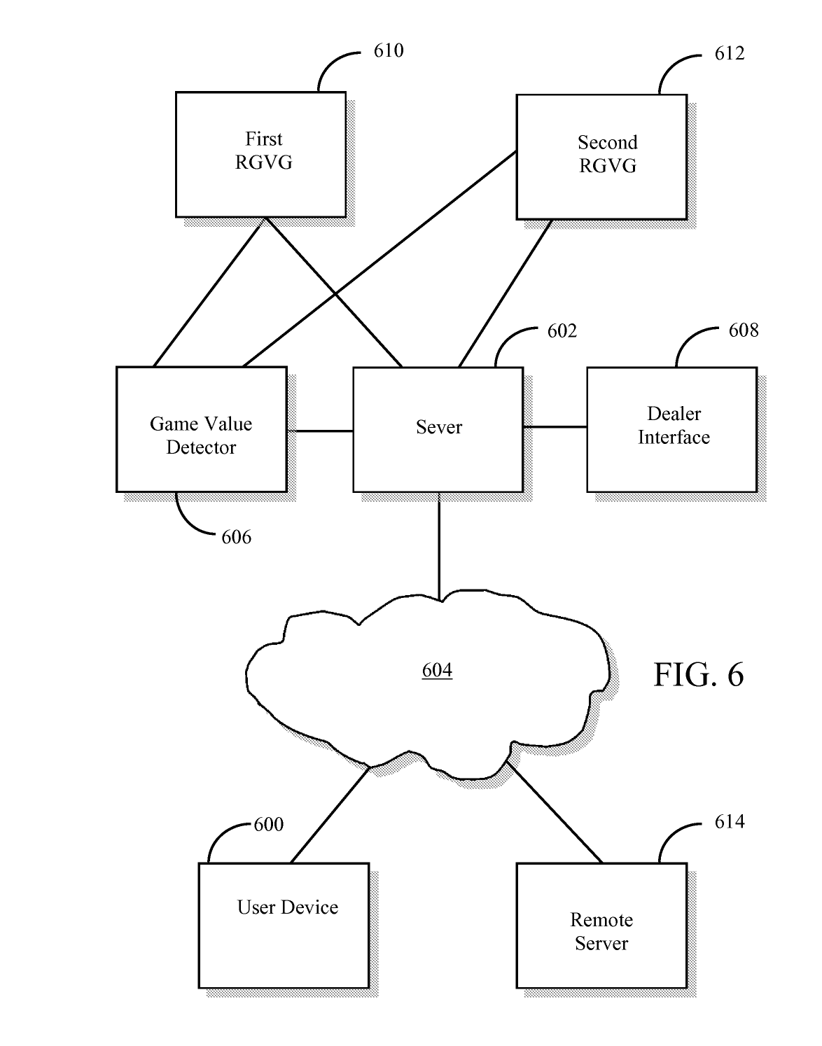

FIG. 6 is a functional block diagram describing another embodiment, where the system allows remote participants to place wagers on players' game outcomes using user device 600 in communication with server 602 over network 604 (e.g., the Internet). Such games may include blackjack, baccarat, roulette, bingo, lottery, keno, etc. User device 600 may comprise any electronic device that is capable of receiving user input and providing electronic representations of the user input to local server 602, typically over network 604. Examples of user device 600 comprise a smart phone, computer, tablet, or a device customized to allow remote players to play a game being played in a remote location. Local server 602 comprises a device similar to local server 200, described above. Local server 602 may be coupled to game value detector 606 for receiving electronic representations of physical game values as a game is played. Game value detector 116 is the same or similar device as game value detector 116 described above, comprising, for example, a card reader or a camera. Local server 602 may also be coupled to dealer interface 608, which comprises at least an output device, such as a display, one or more illumination devices each corresponding to a respective random number generator 610 or 612, or speaker, for providing indications to a live dealer as to which random game value generation device 610 or 612 to use during one or more points during the game. The indications may take the form of a visual or audible signal indicative of a selection of one of the random game value generators. Each of random game value generation devices 610 or 612 can be coupled to either game value detector 116, or directly to server 602 using well-known wired or wireless communication techniques in order to provide random game values to server 602.

The system of FIG. 6 could be used to receive wagers and instructions from remote participants as a game is played inside a casino or other gaming establishment by local game players playing the game on a local gaming surface 106. In this embodiment, the remote players may be permitted to place wagers as to the outcome(s) of the game and, additionally, may be allowed to select which random game value generator to use during certain points during the game. Any variety of games may be played, such as blackjack, poker, baccarat, roulette, bingo, lottery, keno, etc. As an illustrative example, suppose a game of blackjack is being played using the system of FIG. 6. In this example, game value detector 606 may comprise a video camera for providing a video feed of the blackjack game to one or more remote participants as the game is being played on gaming surface 106 by a number of local players inside a casino. Game values are provided to the players by a live dealer in the form of, in this embodiment, either physical playing cards dealt from a first shoe 610, which is red in color, or physical playing cards from a second shoe 612, which is blue in color. In this embodiment, each shoe contains the same number of physical playing cards, although in other embodiments, there could be a greater or fewer number of physical playing cards in one shoe vs. the other. One or more remote participants may place wagers and/or provide instructions to the dealer using a respective user device 600.

In one embodiment, before the start of a round of game play, the remote participant may be allowed to select which of the shoes, 610 or 612, for the dealer to use to provide initial hands to the players and dealer. For example, a remote participant may select the red shoe by entering his selection into user device 600. User device 600, in turn, sends a signal to server 602 via network 604 for the dealer to deal the initial hands from the red shoe, and an indication of such is provided to dealer interface 608, in this case, an electronic device having two LED indicators: one red and one blue, representing the red and blue shoes. The signal from server 602 illuminates the red LED, notifying the dealer to use the red shoe to provide initial hands to the local blackjack players and the dealer, one face up and the other face down. Each of the cards dealt from the red shoe is captured by game value detector 606 as a live video stream and provided to the remote participant via network 604 and user device 600 and/or display 614 that is not part of user device 600, such as a TV monitor in a public place, such as a bar, casino, etc.

In the example above, the remote participant may only be given an opportunity to select which shoe to deal the initial cards if a wager is placed within a predetermined time from the start of the game. Wagers may be placed via user device 600 and provided to server 602, or another server tasked with managing an account associated with the remote participant. Wagers may be placed in a number of ways, for example, betting that one or more particular local players' hands will beat the dealer, whether the dealer will go bust, whether a player who “doubles down” will draw a 10 or not, etc. Generally, the remote participant can place one or more wagers before or during the game as it is being played by the local players and dealer.

In a slight variation of the above example, the remote participant may receive his own card hand and play along with the remote players. In this embodiment, the remote participant may place wagers on his own hand in addition to placing wagers on others' hands. The remote participant uses user device 600 (and display 614 in some embodiments) to place receive a video stream from game value detector 116, place wagers, provide commands to the dealer whether to hit or stick or other commands pertinent to a particular game, and inform the dealer which shoe to deal cards from. For example, the remote participant may only be allowed to select one of the shoes for receiving cards when the player splits his hand or doubles down.

Another example of use of the system in FIG. 6 is the ability of local players, or one or more remote participants, to place a wager during a baccarat game, for example, after the initial bank and player hands are dealt. Server 602 or dealer interface 608 could start a timer, giving the players/participants a chance to place a wager on the outcome of the game within a predetermined time period, such as 30 seconds. Server 602 may either randomly select the source of other cards to complete the game after the time period expires, or any of the local players or remote participants may select the source, in accordance with “house rules”. If server 602 determines which shoe to use, it may provide a signal to dealer interface 608, indicating which of the shoes to provide the next card or cards.

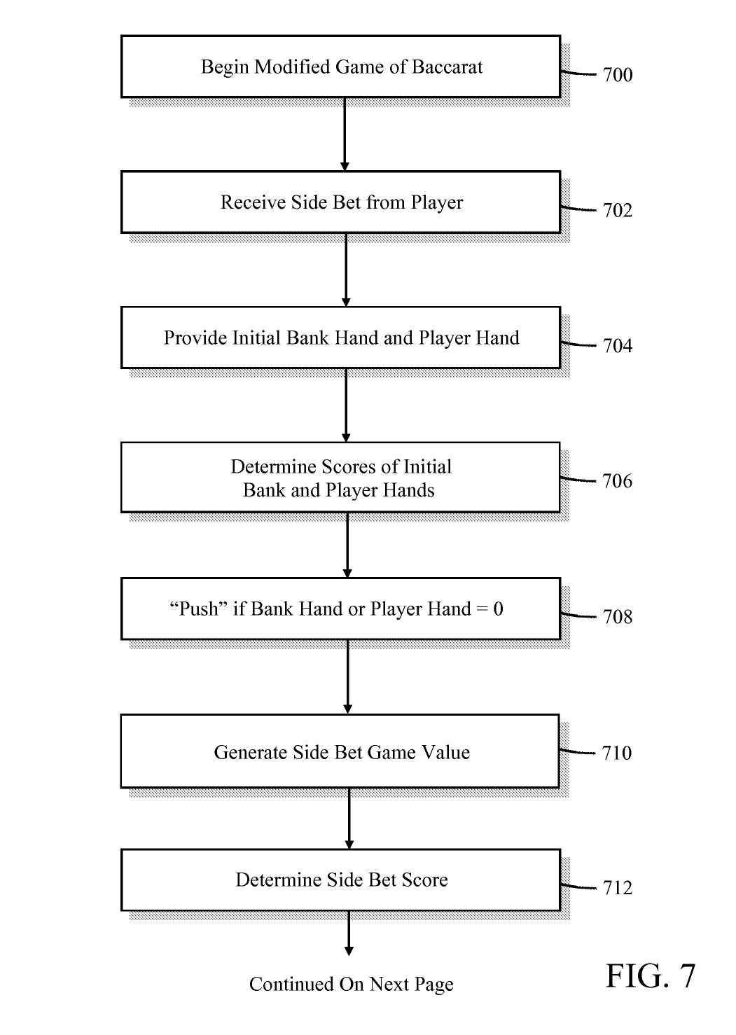

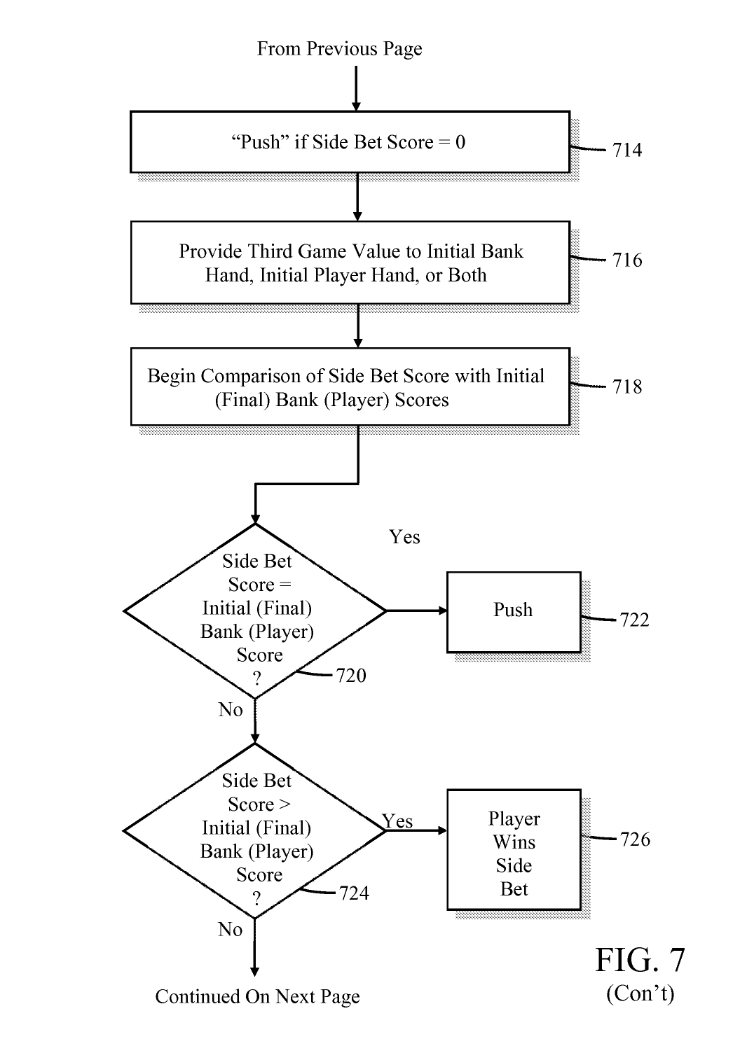

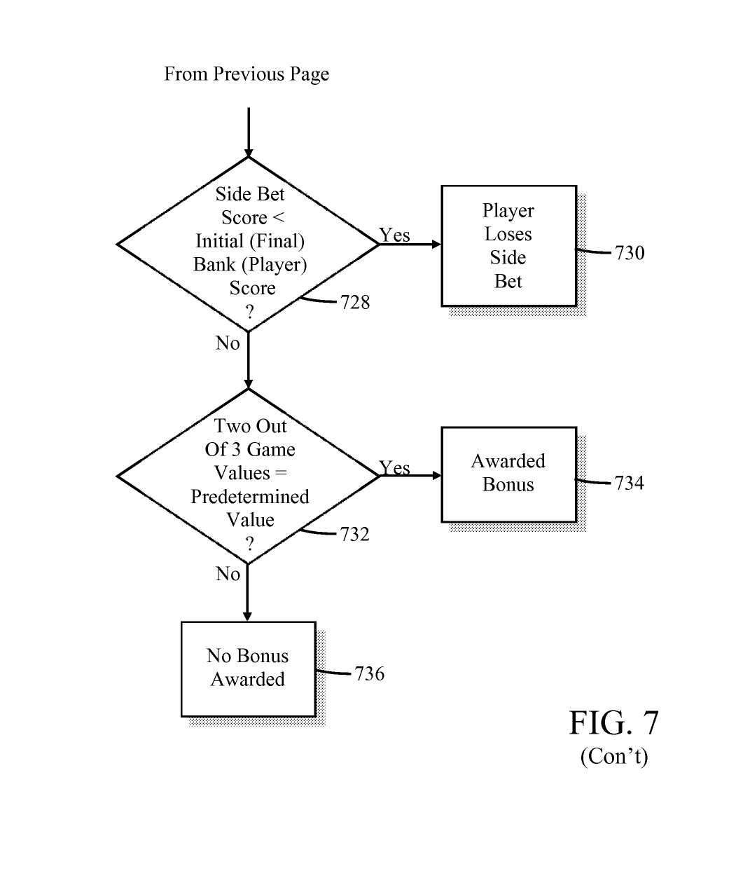

FIG. 7 is a flow diagram illustrating one embodiment of a method for playing a modified game of baccarat, using the principles disclosed herein. The method is implemented by a server, such as server 200 or server 304, shown in FIG. 3, or processor 502 of FIG. 5, executing machine-readable instructions stored by the server in a respective memory. This method allows players and/or participants to place side bets while avoiding disruption of game values provided by a primary random game value generator, such as a shoe holding one or more sets of physical playing cards. Such disruption may disturb some players/participants to the point of leaving the game. It should be understood that in some embodiments, not all of the steps shown in FIG. 7 are performed and that the order in which the steps are carried out may be different in other embodiments. It should be further understood that some minor method steps have been omitted for purposes of clarity.

At block 700, a modified game of baccarat begins as one or more players and/or participants each places a traditional wager, either on gaming surface 106, via user interface 212, 404, or via user device 600, for either the bank hand to beat the player hand or vice-versa, or a tie, at the conclusion of the round of game play.

At block 702, players may place a side bet, either on gaming surface 106, via user interface 212, 404, or user device 600. The side bet relates to whether a card drawn from a second random game value generator will beat a score of an initial bank hand provided from a first random game value generator. In another embodiment, the side bet relates to whether a card drawn from the second random game value generator will beat a score of an initial player hand provided from the first random game value generator. In another embodiment, both types of side bets are available to players/participants. In yet another embodiment, the side bet is placed after the initial bank and player hands have been provided, and the side bet relates to whether the game value provided by the second random game value generator will beat a final score of the bank hand and/or the player hand, in accordance with the rules of baccarat. More information regarding the side bet will be provided later herein. It should be understood that any reference to the initial bank hand shall also be construed to describe a side bet with respect to the initial player hand in the alternative, or two side bets, one with respect to the initial bank hand and another to the initial player hand. In any event, the side bet is received by either server 200, server 304, or processor 502 inside gaming machine 500.

At block 704, initial bank and player hands are provided by a first random game value generator. In one embodiment, the first random game value generator comprises one or more decks of physical playing cards or a shoe that hold the one or more decks of physical playing cards. In another embodiment, the first random game value generator comprises a processor executing random number generation code stored in a memory. In some embodiments, a game value detector provides electronic representations of physical game values to a processor in server 200 or server 304. In some embodiments, the initial bank and player hands are provided to user device 600 and/or display 614 over network 604 for display to a remote game participant.

At block 706, an initial bank hand score is calculated and/or an initial player hand score is calculated, by either server 200, server 304, or processor 702, in accordance with the rules of baccarat, to generate a score between 0 and 9.

At block 708, in one embodiment, if the initial player hand score or the initial bank hand score equals zero, in accordance with the rules of blackjack, a “push” or tie is determined for the side bet described in block 702, and any player/participant who placed a bet receives his or her money back.

At block 710, a side bet game value is generated by a second random number generator different than the first random number generator that provided the initial bank and player hands. The second random game value generator may comprise an electronic random value generator, such as electronic device 114, a remote entity as described with respect to FIG. 5, a second set of physical playing cards, a mechanical “wheel of fortune” having card values assigned to various portions of the wheel, etc. The side bet game value is provided to server 200, server 304, or processor 702, in accordance with the rules of baccarat, to generate a score between 0 and 9. In one embodiment, the side bet game value is used to determine side bet outcomes for any player/participant who placed a side bet. In another embodiment, multiple side bet game values are generated, one for each player/participant who placed a side bet.

At block 712, a side bet score of the side bet game value is determined by server 200, server 304, or processor 702, in accordance with the rules of baccarat, to generate a score between 0 and 9. In an embodiment where multiple side bet game values are generated, server 200, server 304, or processor 702 determines a side bet score associated with each of the side bet game values.

At block 714, in one embodiment, if the side bet score is equal to 0 (e.g., the side bet game value is a 10, jack, queen, or king), a “push” or tie is determined at block 716 for the side bet described in block 702, and any player/participant who placed a side bet receives his or her side bet money back. In an embodiment where multiple side bet game values are provided to each player/participant, respectively, any player whose side bet score is equal to 0 receives his or her side bet money back.

At block 716, in one embodiment, a third card value is provided to either the initial bank hand, the initial player, or both, when the rules of baccarat dictate so, the third card value generated by the first random game value generator. In another embodiment one of the players/participants is given a choice to select either the first random game value generator or the second random game value generator from which to provide the third card(s). In any case, a final bank hand score and/or a final player hand score is calculated, in accordance with traditional rules of baccarat.

At block 718, in one embodiment, the initial bank hand score is compared to the side bet score by server 200, server 304, or processor 702 to determine if the side bet was successful. If multiple side bet game values were used, each side bet score is compared to the initial bank hand score. In an embodiment where the side bet relates to the side bet score vs. a final bank and/or player hand score, the side bet score(s) is/are compared to the final bank and/or player hand scores. In an embodiment where the side bet relates to a comparison of the side bet score(s) to the final bank and/or player hand scores, the side bet score is compared to the final bank hand score, the final player hand score, or both.

At block 720, in one embodiment, if the side bet score is equal to the initial (or final) bank hand score, a “push” is determined at block 722 for the side bet described in block 702, and any player/participant who placed a bet receives his or her side bet money back. If multiple side bet game values were used, a push is determined for each player/participant whose side bet score equals the initial (final) bank hand score.

At block 724, if the side bet score is greater than the initial (final) bank (player) hand score, the side bet is successful, and the player/participant who placed the side bet receives a credit or a payout at block 726. If multiple side bet game values were used, any player/participant whose side bet score is greater than the initial (final) bank (player) hand score receives a payout.

At block 728, if the side bet score is less than the score of the initial (final) bank (player) hand score, the side bet is unsuccessful, and the player/participant who placed the side bet loses the side bet in block 730. If multiple side bet game values were used, any player/participant whose side bet score is less than the initial (final) bank (player) hand score loses his or her side bet.

In one embodiment, a bonus award may be paid to players/participants in addition to the side bet examples described above. For example, at block 732, if two of the three card values among the side bet game value and the two initial bank hand game values (or the two initial player hand game values) are equal to a predetermined game value (for example an “8”), a bonus payout could be awarded to a player/participant who placed a side bet, shown in block 734. In another example, at block 732, if all card values among the initial bank (player) hand and the side bet game value are equal to a predetermined card value, then a bonus payout could be awarded to a player/participant who placed a side bet.

The use of multiple sets of game values, such as use of two shoes on a blackjack or baccarat table, could make the dealer's job of sorting cards time consuming. For example, after each round of blackjack, the dealer may have to separate cards provided from the first shoe from those provided by the second shoe at the conclusion of each round of game play. This may especially be the case when the game values are different from each other, such as in the case of one shoe comprising 8 decks of physical playing cards, each having one of 52 unique combinations of suit and number, and the other shoe comprising physical playing cards having “face cards” only, i.e., only 10 through King for determining the outcome of a side bet of a particular game.

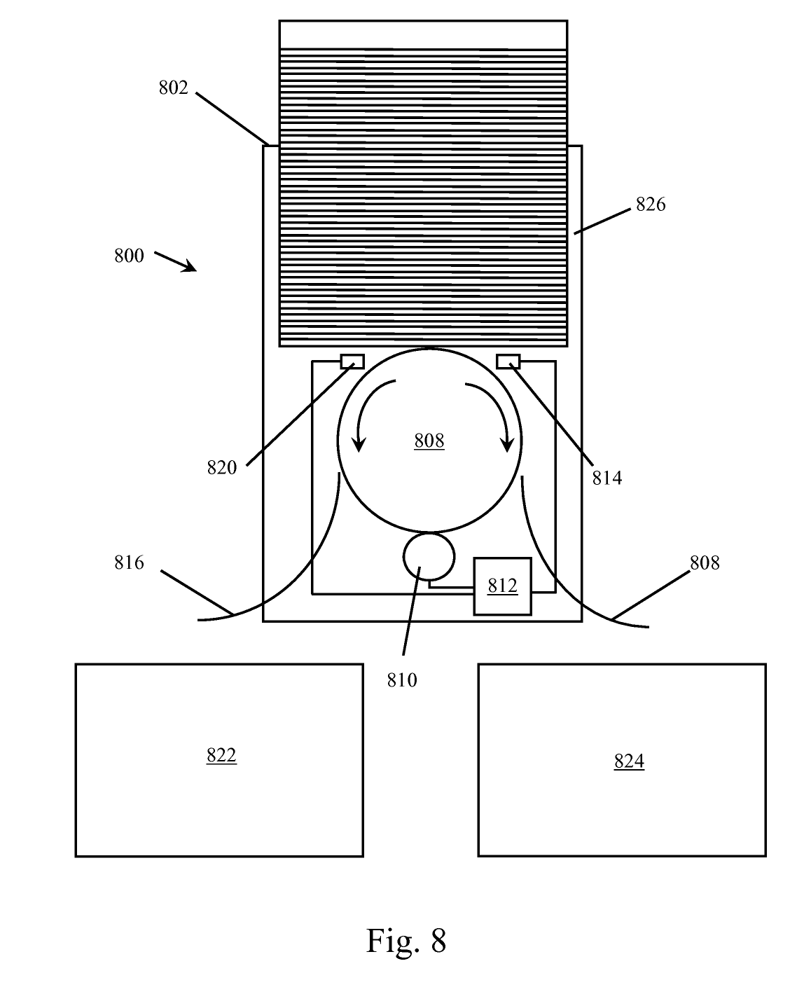

FIG. 8 illustrates one embodiment of an automated sorter 800 that distinguishes between each set of game values, e.g. cards from a first source of game values vs. cards from a second source of game values. A combined set of cards is provided to the sorter 800 via opening 802, and then the sorter 800 separates the cards into two sets based on an indicator placed on at least each of one set of card values. For example, a first set of card values could comprise a typical, 52 card deck of playing cards, while a second set of cards could comprise another 52 card deck of playing cards, with an identifier formed on the face, or embedded, into each of the second set of cards. The identifier may comprise anything that allows sorter 800 to identify cards bellowing to the second set, such as an RFID chip, a particular color, a bar code, a particular image, etc. As a number of cards are placed in opening 802, the lead card 806 rests against drum 808. Drum 808 is in mechanical communication with motor 810, which turns the drum one way or the other, depending on whether lead card 806 is determined to have the indicator on/in it. The determination is made by processor 812 in conjunction with detector 814. Detector 814 is an optical, electronic, RFID, or other detection device that can detect when a card comprises one of the identifiers on/within it. Detector 814 provides signals to processor 812 upon detection of a card having an identifier on it. Processor 812, in turn, provides a signal to motor 810 to turn drum 808 in a direction to “peel” lead card 806 off of the stack of cards and onto tray 816, for example, the tray designated for cards having an indicator on/within it. If detector 814 does not detect an indicator, a signal is sent to processor 812 indicating such, and processor 812 sends a signal to motor 810 to drive drum 808 in an opposite direction from the previous example, so that lead card 806 is peeled off and onto tray 818, the tray designated for cards that do not have an indicator on/within them. Of course, each set of cards could have their own indicator on/within each card of each set. For example, each of a first deck of cards could comprise an RFID chip while each of a second deck of cards could comprise a small red square placed onto the face of each card. Detector 814 could comprise an RFID reader for detecting cards having an RFID chip, while a second detector 820, in this example an optical detector, could be used to detect cards having the small red square thereon. Detector 820 is also coupled to processor 812 to provide signals to processor 812, indicating the presence, or absence, of a card having the small red square.

Sorter 800 may additionally incorporate a shuffler commonly used in the gaming industry to shuffle one or more decks of playing cards. Such a sorting device could be used to shuffle cards before they are sorted, or after. For example, shuffler 822 could be used to shuffle cards from tray 816 after a predetermined number of cards have been delivered to tray 816, while shuffler 824 could be used to shuffle cards from tray 818 after a predetermined number of cards have been delivered to tray 818. Each of the shufflers may be physically incorporated into sorter 800, for example, physically attached or replacing the trays 818 and 818, or a single shuffler may be physically incorporated into a chute 826 used to hold the mixed set of cards.

The methods or steps described in connection with the embodiments disclosed herein may be embodied directly in hardware or embodied in machine-readable instructions executed by a processor, or a combination of both. The machine-readable instructions may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. In the alternative, the processor and the storage medium may reside as discrete components.

Accordingly, an embodiment of the invention may comprise a non-transitory processor-readable media embodying code or machine-readable instructions to implement the teachings, methods, processes, algorithms, steps and/or functions disclosed herein.

While the foregoing disclosure shows illustrative embodiments of the invention, it should be noted that various changes and modifications could be made herein without departing from the scope of the invention as defined by the appended claims. The functions, steps and/or actions of the method claims in accordance with the embodiments of the invention described herein need not be performed in any particular order. Furthermore, although elements of the invention may be described or claimed in the singular, the plural is contemplated unless limitation to the singular is explicitly stated.

I claim:

1. A gaming system, comprising:
a surface on which to play a game;
first means for providing a first random gaming value to a game player on the surface during execution of the game; and
second means for providing a second random gaming value to the game player on the surface when a predetermined event occurs, the second random gaming value provided in response to an instruction from the game player to receive the second random gaming value.

2. The gaming system of claim 1, wherein the first random gaming value is provided to the game player by a dealer in response to the dealer choosing to provide a random game value to the game player during execution of the game.

3. The gaming system of claim 1, wherein the predetermined event comprises a time that occurs prior to a start of the game.

4. The gaming system of claim 1, wherein the predetermined event comprises at a point in the game where the game player may place a wager.

5. The gaming system of claim 1, wherein the game player determines which of the first means or second means to provide one or more random game values to the game player at predetermined points during execution of the game.

6. The gaming system of claim 1, wherein the dealer determines which of the first means or second means to provide one or more random game values to the game player at predetermined points during execution of the game.

7. The gaming system of claim 1, wherein the dealer determines which of the first means or second means to provide one or more random game values to the game player at predetermined points during execution of the game, and the game player determines which of the first means or second means to provide one or more additional random game values to the game player at other predetermined points during execution of the game.

8. The gaming system of claim 1, wherein the first means comprises one or more physical sets of gaming values, and the second means comprises one or more second physical sets of gaming values.

9. The gaming system of claim 1, wherein the first means comprises one or more physical sets of gaming values, and the second means comprises an electronic random game value generator.

10. The gaming system of claim 1, wherein the first means comprises one or more physical sets of gaming values, and the second means comprises a one or more different physical sets of gaming values.

11. The gaming system of claim 1, further comprising:
a server configured to allow other game players to play the game remotely from the surface over a data network; and
a dealer interface device coupled to the server and configured to:
receive a signal from one of the other game players over the data network indicative of a selection of either the first means or the second means from which to receive a next random game value; and
provide an indication to the dealer of whether to provide the next random game value from the first means or the second means in accordance with the signal received from the from the one of the other game players.

12. The gaming system of claim 1, further comprising:
a server configured to allow a remote game participant to place remote wagers on the game player's outcome over a data network; and
a dealer interface device coupled to the server and configured to:
receive a signal from the remote game participant over the data network indicative of a selection of either the first means or the second means from which to generate a next random game value; and
provide an electronically-generated random game value for use in the game to the remote game participant over the data network.

13. A gaming system, comprising:
a gaming table;
a first set of gaming values; and
a second set of gaming values;
wherein one or more gaming values from the first set of gaming values are randomly provided to a game player by a dealer during execution of a game played on the gaming table; and
at least one of the second set of game values is randomly provided to the game player by the dealer during execution of the game in response to the game player requesting a game value from either the first or the second set of gaming values.

14. The gaming system of claim 13, wherein the dealer provides the gaming values to the game player from either the first set of gaming values or the second set of gaming values in accordance with a selection by the game player of either the first or the second set of gaming values.

15. The gaming system of claim 13, wherein selection of either the first or the second set of game values by the game player occurs prior to a start of the game.

16. The gaming system of claim 13, wherein the game player selects the at least one of the second set of game values prior to placing a wager.

17. The gaming system of claim 13, wherein the dealer selects an additional game value from either the first or the second set of game values during execution of the game and provides the additional game value to the game player.

18. A gaming system, comprising:
a first set of physical game values;
a memory for storing machine-readable instructions;
an electronic random game value generator;
a user interface;
a processor coupled to the game value recognition device, the memory, the electronic random game value generator, and the user interface for executing the machine-readable instructions that cause the gaming system to:
receive an indication from a player of the game, from the user interface, of a selection by the player to receive a random game value from either the first set of physical game values or the electronic random game value generator;
when the indication indicates selection of the random game value generator:
providing an electronically-generated random game value to the user interface for use by the player in the game.

19. The gaming system of claim 17, further comprising:
a game value recognition device, coupled to the processor, configured to provide an electronic representation of the physical game values as the physical game values are used during execution of a game;
wherein the processor is further configured to:
receive an electronic representation of a physical game value from the first set of physical game values by the game value recognition device as the physical game value is provided to the player;
remove from the physical game value received from the game value recognition device from being considered as the electronically-generated random game value during subsequent play of the game.
